(19) United States
(12) Patent Application Publication
(10) Pub. No.: US 2016/0086088 A1
(43) Pub. Date: Mar. 24, 2016

(54) FACILITATING DYNAMIC AFFECT-BASED ADAPTIVE REPRESENTATION AND REASONING OF USER BEHAVIOR ON COMPUTING DEVICES

(71) Applicants: RAANAN YONATAN YEHEZKEL, Kiryat Ekron (IL); DAVID STANHILL, Hoshaya (IL)

(72) Inventors: RAANAN YONATAN YEHEZKEL, Kiryat Ekron (IL); DAVID STANHILL, Hoshaya (IL)

(21) Appl. No.: 14/495,094

(22) Filed: Sep. 24, 2014

(51) Int. Cl. G06N 5/04; G06N 99/00

(52) U.S. Cl. CPC G06N 5/04; G06N 99/005

(57) ABSTRACT

A mechanism is described for facilitating affect-based adaptive representation of user behavior relating to user expressions on computing devices according to one embodiment. A method of embodiments, as described herein, includes receiving a plurality of expressions communicated by a user. The plurality of expressions may include one or more visual expressions or one or more audio expressions. The method may further include extracting a plurality of features associated with the plurality of expressions, where each feature reveals a behavior trait of the user when the user communicates a corresponding expression. The method may further include mapping the plurality of expressions on a model based on the plurality of features, and discovering a behavioral reasoning associated with each of the plurality of expressions communicated by the user based on a mapping pattern as inferred from the model.

### FIELD

Embodiments described herein generally relate to computers. More particularly, embodiments relate to facilitating dynamic affect-based adaptive representation and reasoning of user behavior relating to user expressions on computing devices.

### BACKGROUND

Human beings express their affective states (e.g., emotional states) in various ways, often involuntarily. These affective states include facial expressions, head nodding, varying voice characteristics, spoken words, etc. With the increase in the use of computing devices, such as mobile computing devices, such emotional expressions are becoming increasingly important in determining human behavior. However, conventional techniques do not provide for detecting these human expressions with sufficient accuracy and consequently, these techniques are incapable of determining human behavior.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a dynamic affect-based adaptive user behavior mechanism according to one embodiment.

FIG. 2A illustrates a dynamic affect-based adaptive user behavior mechanism according to one embodiment.

FIG. 2B illustrates a manifold according to one embodiment.

FIG. 2C illustrates a manifold according to one embodiment.

FIG. 2D illustrates a graph having user expression points planted in various clusters according to one embodiment.

FIG. 3A illustrates a transaction sequence for efficiently performing affect-related adaptive representation and reasoning of user behavior relating to users expressions according to one embodiment.

FIG. 3B illustrates a sectional transaction sequence of the transaction sequence of FIG. 3A for efficiently performing affect-related adaptive representation and reasoning of user behavior relating to users expressions according to one embodiment.

FIG. 3C illustrates a transaction sequence for efficiently performing affect-related adaptive representation and reasoning of user behavior relating to users expressions according to one embodiment.

FIG. 3D illustrates a method for efficiently performing affect-related adaptive representation and reasoning of user behavior relating to users expressions according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for automatically detecting, analyzing, and recognizing user expressions (e.g., facial expressions, voice characteristics, etc.) to facilitate efficient and tailored services to users. Embodiments provide for determining representation and reasoning relating to emotional states of humans, such as individual humans or groups of humans, by adaptively modeling and learning their expressions.

It is contemplated that each human (even those belonging to a group of humans with similar characteristics, such as age, gender, culture, ethnicity, etc.) may express emotions in a unique manner. For example, a smile of one person may be at least slightly different from another person's smile. There variations, for example, may be due to physiological differences or personality. Further, different set of emotions may be relevant in different situations or under different context. For example, watching an action movie may result in some set of emotion that may be different than the set of emotions involved during a video-chat of a romantic nature. For example, even if both viewers scream during a horror movie, one viewer may be enjoying the scene, but the other viewer may be genuinely scared. In one embodiment and as will be further describe below, this difference may be evaluated from detecting the variance in the two screams and other unique user behaviors. Further, any set of relevant emotions may not be defined beforehand.

Embodiments provide for a mechanism to employ one or more of the following techniques or capabilities (without limitation): 1) user adaptive technique to allow for learning the behavioral characteristics of a specific user or a group of users; 2) task/context adaptive technique to allow for easily adapting to different reasoning tasks and/or context/scenario; for example, one task may be used for classifying into one of six basic emotions (e.g., six defined facial expressions), where another tasks may be used for identifying a valence level (e.g., how positive is an emotion as opposed to how negative is the emotion); 3) discover new states technique to allow for automatically identifying new classes of affective states, such as the ones that are not defined by the user; 4) incorporating external knowledge and concept technique to allow for obtaining additional knowledge, for example, from knowing the configuration (e.g., frontal faces) or from a context to naturally incorporated into the mechanism; 5) continues valued and categorical outputs technique to allow for supporting multiple types of outputs; for example, two types of output where a first type includes a categorical output where a facial expression is classified into one class (e.g., category) from a set of classes (e.g., smile, anger, etc.), and a second type includes a vector of values representing coordinates in a predefined space (e.g., two-dimensional (“2D”) space where the first axis represents valence level and the second axis represents arousal; and 6) enable complicated reasoning and inference tasks technique to allow for employing simple and common algorithms, such as when applied to the mechanism, corresponding to a range of complicated reasoning and inference tasks.

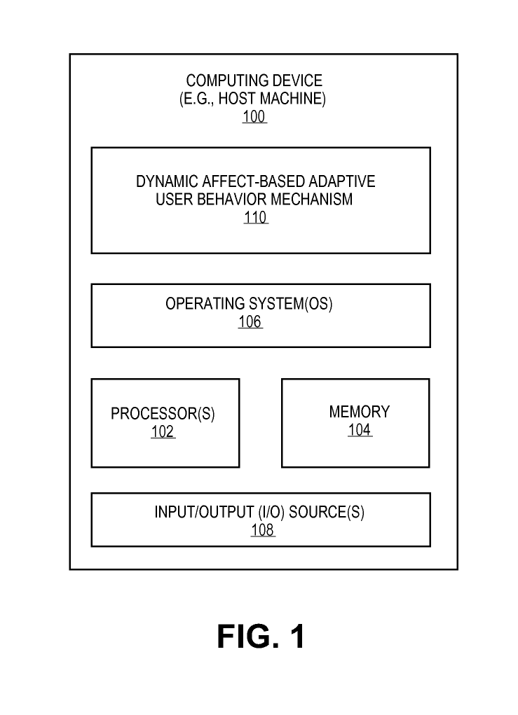

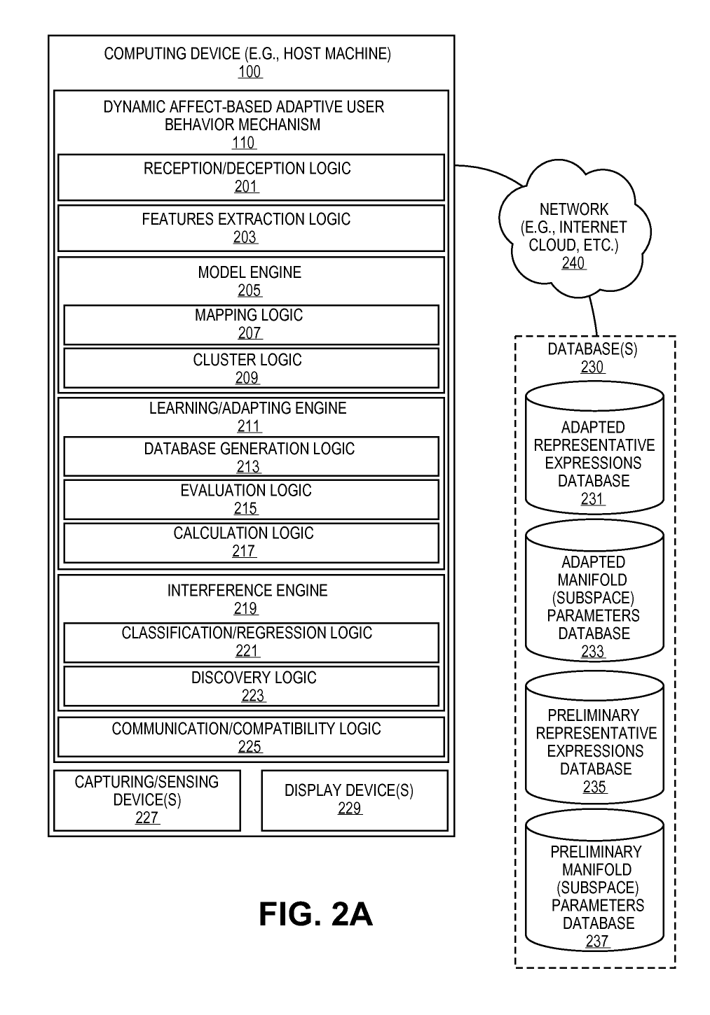

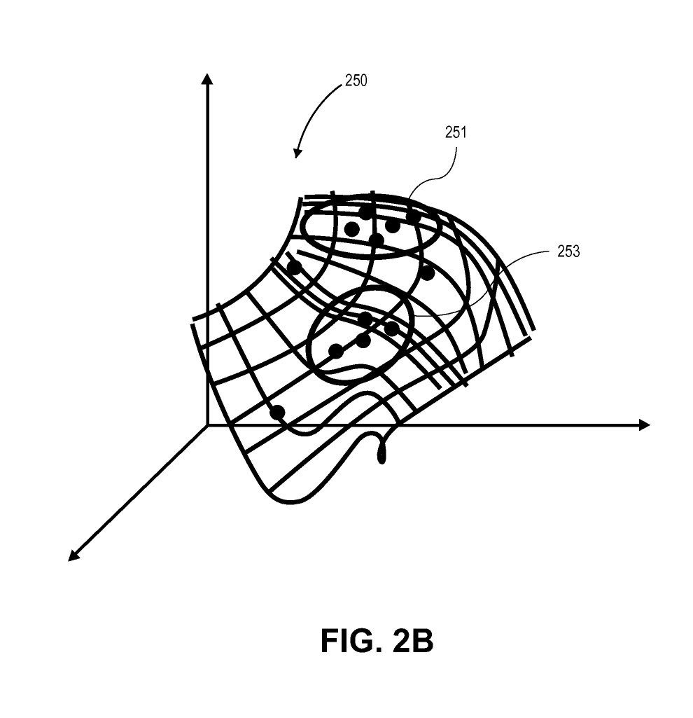

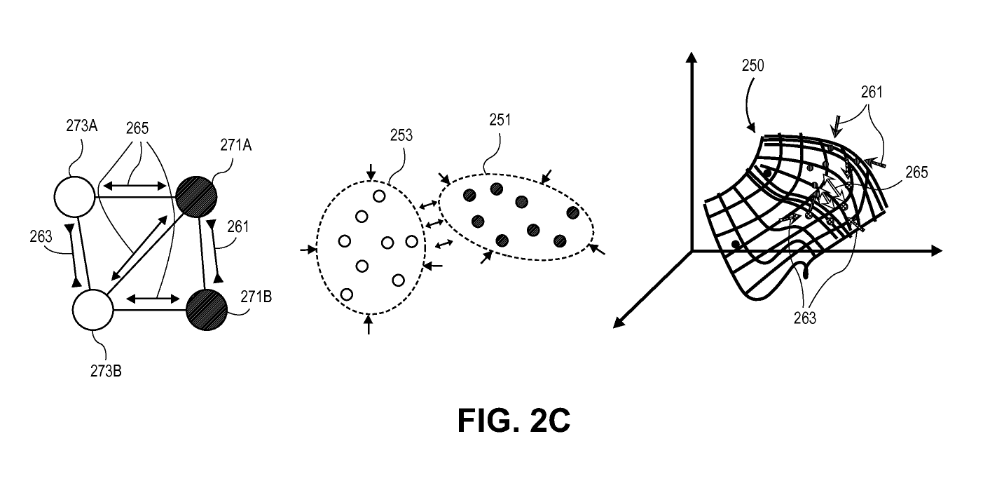

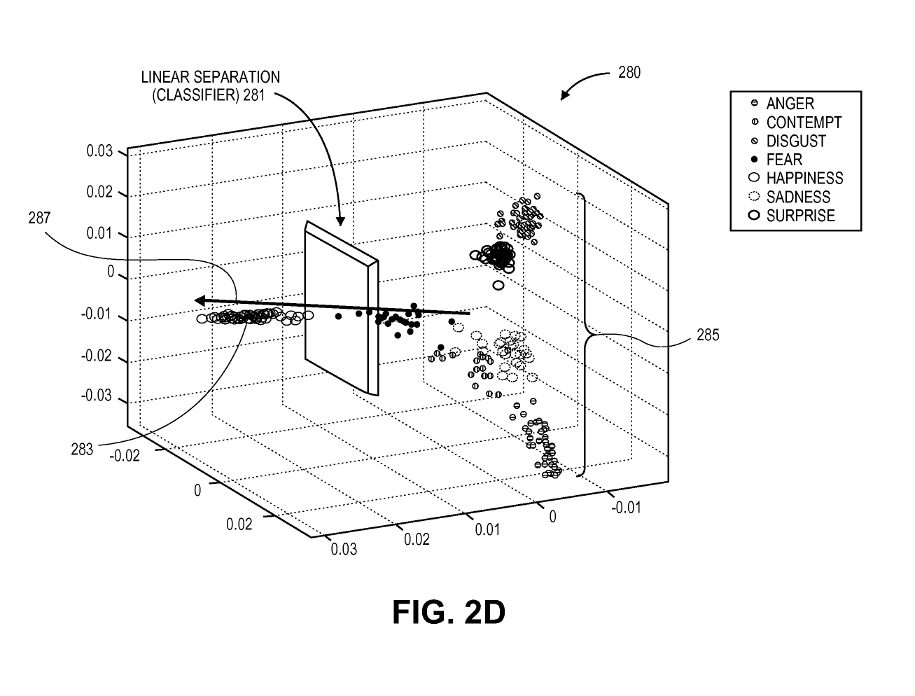

FIG. 1 illustrates a computing device 100 employing a dynamic affect-based adaptive user behavior mechanism 110 according to one embodiment. Computing device 100 serves as a host machine for hosting dynamic affect-based adaptive user behavior mechanism (“behavior mechanism”) 110 that includes any number and type of components, as illustrated in FIG. 2, to efficiently perform dynamic, intelligent, and efficient affect-related adaptive representation and reasoning of user behavior as will be further described throughout this document.

Computing device 100 may include any number and type of communication devices, such as large computing systems, such as server computers, desktop computers, etc., and may further include set-top boxes (e.g., Internet-based cable television set-top boxes, etc.), global positioning system (“GPS”)-based devices, etc. Computing device 100 may include mobile computing devices serving as communication devices, such as cellular phones including smartphones (e.g., iPhone® by Apple®, BlackBerry® by Research in Motion®, etc.), personal digital assistants (“PDAs”), tablet computers (e.g., iPad® by Apple®, Galaxy 3® by Samsung®, etc.), laptop computers (e.g., notebook, netbook, Ultrabook™ system, etc.), e-readers (e.g., Kindle® by Amazon®, Nook® by Barnes and Nobles®, etc.), media internet devices (“MIDs”), smart televisions, television platforms, wearable devices (e.g., watch, bracelet, smartcard, jewelry, clothing items, etc.), media players, etc.

Computing device 100 may include an operating system (“OS”) 106 serving as an interface between hardware and/or physical resources of the computer device 100 and a user. Computing device 100 further includes one or more processors 102, memory devices 104, network devices, drivers, or the like, as well as input/output (“I/O”) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100. Further, terms like “dot” and “point” may be referenced interchangeably throughout this document.

FIG. 2A illustrates a dynamic affect-based adaptive user behavior mechanism 110 according to one embodiment. In one embodiment, computing device 100 hosts behavior mechanism 110 including any number and type of components, such as (without limitation): detection/reception logic 201; features extraction logic (“extraction logic”) 203; model engine 205 including mapping logic 207 and cluster logic 209; learning/adapting engine (“learning engine”) 211 including database generation logic (“generation logic”) 213, evaluation logic 215, and calculation logic 217; inference engine 219 including classification/regression logic 221 and discovery logic 223; and communication/compatibility logic 225. Computing device 100 may further include capturing/sensing device(s) 227 and display device(s) 229. Further, computing device 100 may be further in communication with one or more databases 230, such as adapted representative expressions database (“adapted representative database”) 231, adapted manifold/subspace parameters database (“adapted manifold database”) 233, preliminary representative expressions database (“preliminary representative database”) 235, and preliminary manifold/subspace parameters database (“preliminary manifold database”) 237, over one or more networks, such as network 240.

In addition to hosting behavior mechanism 110, computing device 100 may further include one or more capturing/sensing device(s) 227 including one or more capturing devices (e.g., cameras, microphones, sensors, accelerometers, illuminators, etc.) that may be used for capturing any amount and type of data, such as images (e.g., photos, videos, movies, audio/video streams, etc.), audio streams, biometric readings, environmental/weather conditions, maps, etc., where one or more of capturing/sensing device 227, such as a camera, may be in communication with one or more components of behavior mechanism 110, such as reception/detection logic 201, to receive or recognize, for example, an audio/video stream having multiple images as captured by one or more capturing/sensing devices 227, such as a camera. The video and/or audio of such audio/video stream may then be used for various tasks being performed by behavior mechanism 110, such as learning of and/or adapting based on human expressions and/or surrounding environment, inference of human behavior based on the learning and adapting, etc. It is further contemplated that one or more capturing/sensing devices 227 may further include one or more supporting or supplemental devices for capturing and/or sensing of data, such as illuminators (e.g., infrared (“IR”) illuminator, etc.), light fixtures, generators, sound blockers, amplifiers, etc.

It is further contemplated that in one embodiment, capturing/sensing devices 227 may further include any number and type of sensing devices or sensors (e.g., linear accelerometer) for sensing or detecting any number and type of contexts (e.g., estimating horizon, linear acceleration, etc., relating to a mobile computing device, etc.) which may then be used by behavior mechanism 110 to perform one or more tasks relating to torsion estimation and such to for accurate eye tracking as will be further described throughout this document. For example, capturing/sensing devices 227 may include any number and type of sensors, such as (without limitations): accelerometers (e.g., linear accelerometer to measure linear acceleration, horizon accelerometer to estimate the horizon, etc.); inertial devices (e.g., inertial accelerometers, inertial gyroscopes, micro-electro-mechanical systems (“MEMS”) gyroscopes, inertial navigators, etc.); gravity gradiometers to study and measure variations in gravitation acceleration due to gravity, etc.

For example, capturing/sensing devices 227 may further include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (“GPS”) sensors; resource requestor; and trusted execution environment (“TEE”) logic. TEE logic may be employed separately or be part of resource requestor and/or an I/O subsystem, etc.

Computing device 100 may further include one or more display device(s) 229, such as a display device, a display screen, audio speaker, etc., that may also remain in communication with one or more components of behavior mechanism 110, such as with communication/compatibility logic 225, to facilitate displaying of images/video, playing of audio, etc.

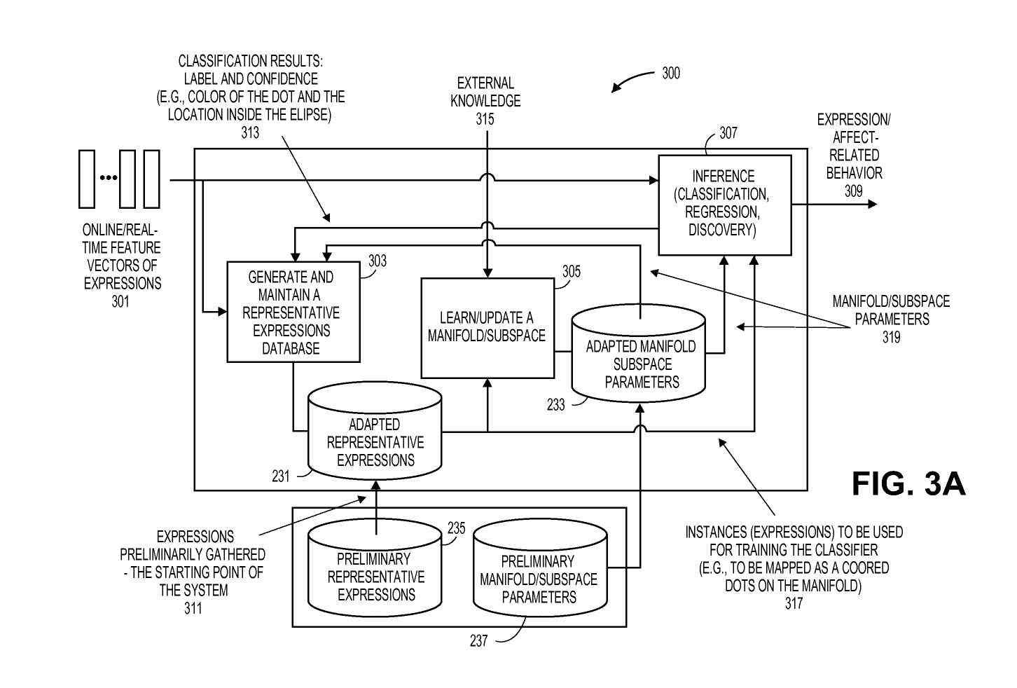

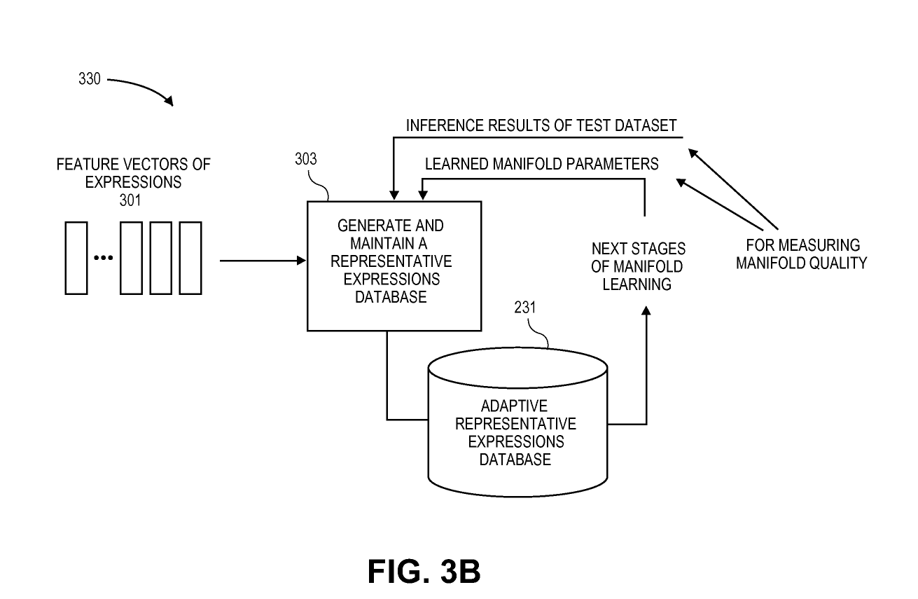

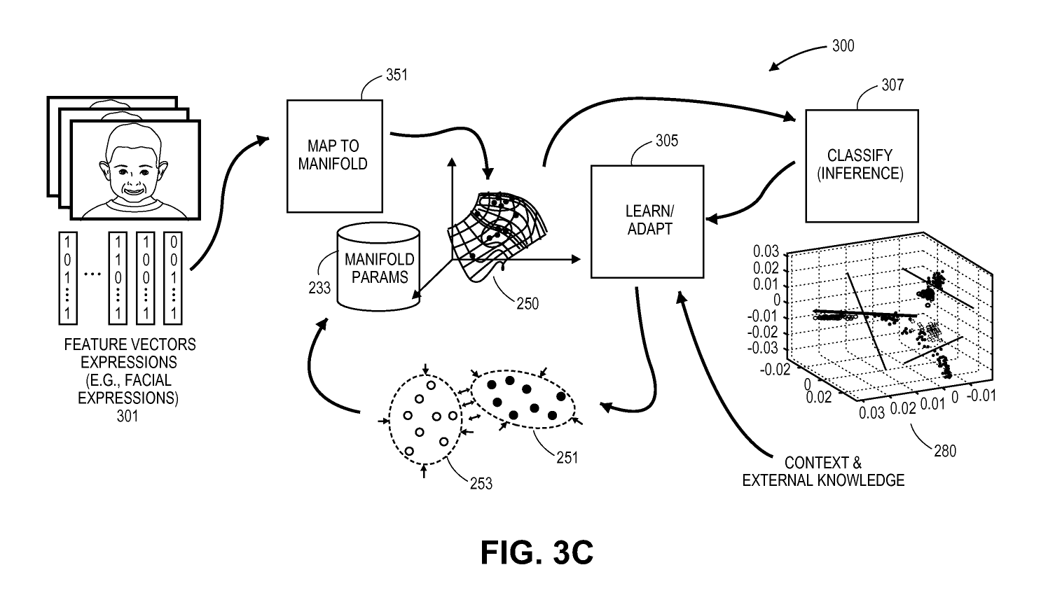

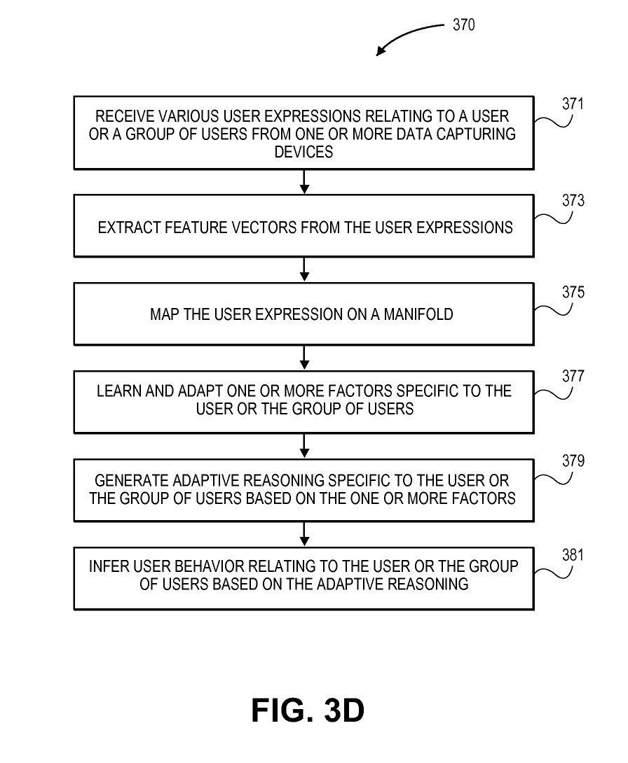

Computing device 100 may include a mobile computing device (e.g., smartphone, tablet computer, etc.) which may be communication with one or more repositories or databases, such as database(s) 230, where any amount and type of data (e.g., images, facial expressions, etc.) may be stored and maintained along with any amount and type of other information and data sources, such as resources, policies, etc., may be stored. For example, as will be further described in this document, database(s) 230 may include one or more of adapted representative database 231 and adapted manifold database 233 and their corresponding preliminary representative database 235 and preliminary manifold database 237, etc., as further described with reference to FIG. 3A. Further, computing device 100 may be in communication with any number and type of other computing devices, such as desktop computer, laptop computer, mobile computing device, such as a smartphone, a tablet computer, etc., over one or more networks, such as cloud network, the Internet, intranet, Internet of Things (“IoT”), Cloud of Things (“CoT”), proximity network, Bluetooth, etc.

In the illustrated embodiment, computing device 100 is shown as hosting behavior mechanism 110; however, it is contemplated that embodiments are not limited as such and that in another embodiment, behavior mechanism 110 may be entirely or partially hosted by multiple computing devices, such as multiple client computers or a combination of server and client computer, etc. However, throughout this document, for the sake of brevity, clarity, and ease of understanding, behavior mechanism 100 is shown as being hosted by computing device 100.

It is contemplated that computing device 100 may include one or more software applications (e.g., website, business application, mobile device application, etc.) in communication with behavior mechanism 110, where a software application may offer one or more user interfaces (e.g., web user interface (WUI), graphical user interface (GUI), touchscreen, etc.) to allow for facilitation of one or more operations or functionalities of behavior mechanism 110 and communication with other computing devices and such.

In one embodiment, a camera of capturing/sensing devices 227 may be used to capture a video (e.g., audio/video stream) having a series of images and sounds bites. As will be further described, any number and type of images and/or audio bites from the captured audio/video stream may then be communicated to and received or recognized by reception/detection 201 for further processing by behavior mechanism 110.

It is to be noted that embodiments are not limited to merely facial expressions obtained from images or video clips, etc., and that various sensory characteristics obtained from other sensory data (e.g., sound/audio, biometric readings, eye tracking, body temperature, etc.) may also be used for learning, adapting, and inference of user behavior as facilitated by behavior mechanism 110. However, for the sake of brevity, clarify, and ease of understanding, merely facial expressions are discussed throughout this document.

In one embodiment, various components of behavior mechanism 110 provide for novel and innovative features, such as a model such that various human expressions are represented and modeled by an adaptable model, a process for learning and adapting the model, and a rich set of adaptive reasoning capabilities that are enabled to facilitate inference of the model representing and the human expressions. For example and in one embodiment, human expressions (e.g., facial expressions, voice characteristics, etc.) may be extracted by extraction logic 203 from images received at or recognize by detection/reception logic 201 and captured by capturing/sensing devices 227. These expressions may then be mapped, via mapping logic 207, to a model (e.g., mathematical model, such as a high dimensional complex manifold, etc.). The model may then be adapted, via adaption logic 207, online/on-the-fly to a user or a group of users and further, a large range of reasoning and inference tasks performed on this model become natural and mathematically sound as facilitated by inference logic 209.

As aforementioned, although embodiments are not limited to merely facial expressions and that other types of data (e.g., voice characteristics) may also be used, for the sake of brevity, clarify, and ease of understanding, facial expression is used as an example throughout this document. It is further contemplated any number and type of images and audio streams may be received at or recognize by reception/detection logic 201 and that embodiments are not limited to any particular number, amount, and/or type of images and/or voices; however, for the sake of brevity, clarify, and ease of understanding, merely a single or limited number and type of images may be used as an example throughout the document.

In one embodiment, one or more images (such as from a video stream captured by a video camera of capturing/sensing devices 227) showing a user's various expressions may be received at or recognize by reception/detection logic 201 for further processing. Upon receiving the one or more images of various facial expressions of the user, by reception/detection logic 201, the features, related to facial expressions, may then be extracted by extraction logic 203 (example features are: location of mouth corners, pupils, nose tip, chin, etc. or responses of various 2D image-filters, such as Gabor filters). These facial expressions may include any number and type of facial expressions from minor to major expressions, such as (without limitation): 1) slight movement of the lower lip when the user is smiling as opposed to crying or being scared; 2) dilation of pupils when the user is excited or scared or happy and further, how one pupil dilates differently than the other pupil; 3) change of facial coloration (e.g., blushing, turning red or yellow, etc.) when experiencing different feelings (e.g., receiving compliments, being angry or happy, feeling sick or cold, etc.), etc.

Similarly, facial expressions between two or more users may also be extracted and compared for any number of reasons and/or purposes, such as academic research, marketing purposes, movie analysis, etc. For example, two viewers of a horror movie may both scream when watching a scene in the honor movie, but one viewer may be genuinely scared at watching the scene, while the other viewer may be screaming out of enjoy while watching the scene. Such analysis may be made based on various differences extracted from one or images of the viewers captured by their respective viewing devices (e.g., tablet computer, laptop computer, television, etc.) and the various differences may then be extracted from the one or more images. For example, the scared viewer's cheeks may turn red or their eyes may dilate, the viewer may place their hands trying to cover the eyes or turn their head away (e.g., sideways or backwards, etc.). In one embodiment, these extracted facial expressions of the scared viewer may be compared with or matched against the extracted facial expressions of the other viewer for, for example, movie marketing, academic research, etc.

Similarly, in another embodiment, the extracted facial expressions of the scared viewer may be compared with or matched against the viewer's own facial expressions from the past as may be stored or maintained at one or more of databases 230. As will be further described later in this document, such comparison or matching of the viewer's facial expressions with their own facial expressions may be used not only to more accurately infer the representation of such facial expressions (e.g., exact sentiments as reflected by the facial expressions), but also to further improve future representations by storing and maintaining these newly-obtained facial expressions at databases 230 (e.g., adapted and preliminary manifold database) so they may be to be used for future processes and accurate inferences of user expressions (e.g., visual expressions or characteristics, voice expressions or characteristics, etc.).

In one embodiment, continuing with the facial expressions example, upon extracting the facial expressions by extraction logic 203, these extracted facial expressions are then forwarded on to model engine 205 where each of the extracted expression is appropriate mapped to a point in a mathematical manifold or subspace as facilitated by mapping logic 207. This manifold may represent one or more possible facial expressions (or voice characteristic, in some embodiments), such as for a given setup (e.g., context, task, user, etc.). Moreover, cluster logic 209 of model engine 205 may be triggered to map similar expressions into points on the manifold that are relatively near each other (such as in the same neighborhood) using one or more mathematical algorithms (e.g., Laplacian eigenmaps, etc.).

Continuing with the example relating to facial expressions, for example, extracted or measured features/attributes (e.g., responses to Gabor filters, landmarks on the face, such as points from one or more face trackers, such as Active Appearance Model (“AAM”), Active Shape Model (“ASM”), Constrained Local Model (“CLM”), etc.) from each facial expression. Each facial expression may be represented by a vector of n feature values {X1, . . . , Xn}, the coordinate of a facial expression in an n-dimensional feature space (where each axis represents values of one of the n features).

In one embodiment, still continuing with facial expressions, if one or more possible facial expressions are mapped into a space, as illustrated with respect to FIG. 2B, the mapped expressions may form a low dimensional manifold (although not all value-combinations of the features may represent facial expressions). FIG. 2B illustrates this technique for n=3 which represents three features being extracted from each facial expression and a two-dimensional (“2D”) manifold being formed (which is shown as a grid). As illustrated with respect to FIG. 2B, the axes (x-axis, y-axis) represent the various features or attributes of facial expressions, where these features/attributes may include (without limitation): location of lip edges, nose-tip, chin, pupils, etc. Further, each illustrated point in these axes correspond to a single feature vector extracted from a facial expression image; for example, a single point may correspond to the location of nose-tip, pupils, chin, lips, head-tilt angle, etc. Further, as illustrated with respect to FIG. 2B, each expression may be mapped to the manifold as facilitated by mapping logic 207, where an expression includes a facial expression (such as smile, laugh, blushing, etc.), a voice expression (such as husky voice, crying voice, high-pitched laugh, etc.), etc. and where each axis represents a feature or attribute of the expression. Upon successful mapping, cluster logic 209 may then concentrate similar expressions together in a smaller area or neighborhood such that dots relating to similar expressions (e.g., smile, cry, etc.) may be clustered together for further processing.

In one embodiment, as illustrated with respect to FIGS. 2B and 3B, the manifold of expressions may then be learned at learning engine 211 by 1) generating a database of adapted representative database 231 and a resulting manifold using database generation logic 213, 2) evaluating any similarities between pairs of expressions using evaluation logic 215, and 3) calculate the manifold using calculation logic 217. For example and in one embodiment, using database generation logic 213, a representative expressions database, such as adapted representative database 231 of databases 230, may be generated and maintained. This database may include feature vectors representing various expressions (e.g., facial expressions, voice expressions, etc.) from which a manifold is learned during the next few processes as will be further described with FIG. 3B.

In one embodiment, upon generating adapted representative database 231 may be used for learning the manifold, such as manifold XX of FIG. 2B, and the learned information about the manifold may then be used for iteratively fine tuning adapted representative database 231 as facilitated by evaluation logic 215. In one embodiment, adapted representative database 231 may contain any amount and type of data, such as pseudo facial expressions and parameters capturing deviations, where pseudo expressions may represent a set of average or photo-typical expressions for different expression categories. For example, and as further described with reference to FIG. 3A, adapted representative database 231 may have direct inputs from and communicated with preliminary representative database 235 and similarly, adapted representative database 231 may be further in communication with one or more of adapted manifold database 233, preliminary manifold database 237, etc.

In one embodiment, the quality of the learned manifold is iteratively evaluated using evaluation logic 215 and the best representative database of expressions is generated as adapted representative database 231 as facilitated by generation logic 213. For example, the quality of the manifold may be represented by the quality of a reasoning task (e.g., classification, regression, etc.) and further, the quality of the manifold may be measured in general (or alternatively) as the quality of reasoning tasks as they relate to specific contexts or the performance of the user.

Further, using evaluation logic 215, similarities between various pairs of expressions (e.g., facial expressions) reflecting user adaptivity may be measured and evaluated. For example and in one embodiment, certain similarities (such as labels, classes, types, etc.) may be taken into consideration and evaluated for each expression, such as facial expressions belonging to the same class or sub-class, under a given context/task, may be considered much more similar to each other than to those of a different class or sub-class. In one embodiment, calculation logic 217 may then be used to determine and calculate the aforementioned similarities between pairs and clusters of expressions using one or more tools or indicators, such as each point may represent a facial expression, each ellipse may represent a confinement of expressions of the same class or context or user, etc., each arrow may represent condensing or stretching of the manifold, etc.

Once user adaptivity or expression similarities have been calculated by calculation logic 217, this information may then be used for the purposes of detecting inference as facilitated by interference engine 219. In one embodiment, for detecting inference, the learned manifold may then be used for classification and regression as facilitated by classification/regression logic 221. For example and in one embodiment, classification/regression logic 221 may serve as a classifier (such as classifier 281 of FIG. 2D) taking in an input of a new vector of feature-values representing user expressions (e.g., facial expressions) and subsequently outputs a specific label from a predefined set of labels (e.g., happy, anger, surprise, etc.). The output of may be used to perform regression in a continuous-valued number (or a set of numbers) that represents a level of some predefined property, such as a level of valance (e.g., how positive is an emotion, such as joy) or stress level, etc. This classification/regression set up is directly learned from the manifold based on true data simulations, as illustrated with reference to FIG. 2D. As aforementioned, each point on the manifold represents an expression, such a facial expression, where each color or shade represents a different class of each emotion, such as different colors/shades representing classes of emotions (e.g., different classes or levels of happiness, sadness, etc.).

In one embodiment, the learned manifold, as illustrated with reference to FIG. 2B, may be used for automatic discovery of new distinct categories of expressions (e.g., facial expressions) for a given classification/regression set up (e.g., context, task, user, etc.) as facilitated by discovery logic 223. For example, unique clusters of points, as illustrated with reference to FIG. 2D, may then be identified using simple and common clustering techniques (e.g., K-means), where each identified cluster may represent a unique category or class of expressions, such as facial expressions.

In one embodiment, as aforementioned, audio/video steams or images may be captured via one or more capturing/sensing devices 227, processed via behavior mechanism 110, and displayed via display devices 229. It is contemplated that behavior mechanism 110 may be used with and in communication with one or more software applications, such as one or more email applications (e.g., Gmail®, Outlook®, company-based email, etc.), text or phone using one or more telecommunication applications (e.g., Skype®, Tango®, Viber®, default text application, etc.), social/business networking websites (e.g., Facebook®, Twitter®, LinkedIn®, etc.), or the like.

Communication/compatibility logic 225 may be used to facilitate dynamic communication and compatibility between computing device 100 and any number and type of other computing devices (such as mobile computing device, desktop computer, server computing device, etc.), processing devices (such as central processing unit (CPU), graphics processing unit (GPU), etc.), capturing/sensing devices 227 (e.g., data capturing and/or sensing instruments, such as camera, sensor, illuminator, etc.), display devices 229 (such as a display device, display screen, display instruments, etc.), user/context-awareness components and/or identification/verification sensors/devices (such as biometric sensor/detector, scanner, etc.), memory or storage devices, databases and/or data sources (such as data storage device, hard drive, solid-state drive, hard disk, memory card or device, memory circuit, etc.), networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, such as Facebook®, LinkedIn®, Google+®, Twitter®, etc., business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “point”, “tool”, and the like, may be referenced interchangeably and include, by way of example, software, hardware, and/or any combination of software and hardware, such as firmware. Further, any use of a particular brand, word, term, phrase, name, and/or acronym, such as “affect-based”, “adaptive representation”, “user behavior”, “gesture”, “manifold”, “model”, “inference”, “subspace”, “classification”, “regression”, “iteration”, “calculation”, “discovery”, “hysteresis points”, “hypothesis cuts”, “text” or “textual”, “photo” or “image”, “video”, “cluster”, “dots”, “lines”, “arrows”, “logic”, “engine”, “module”, etc., should not be read to limit embodiments to software or devices that carry that label in products or in literature external to this document.

It is contemplated that any number and type of components may be added to and/or removed from behavior mechanism 110 to facilitate various embodiments including adding, removing, and/or enhancing certain features. For brevity, clarity, and ease of understanding of behavior mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

Referring now to FIG. 2B, it illustrates a manifold 250 according to one embodiment. As illustrated, manifold 250 representing a grid is holding various possible mapped expressions (e.g., facial expressions) shown as dots within the space of manifold 250. These dots forms a low dimensional manifold (where not all value-combinations of the features representing expression may be included), such as, as illustrated, a number of features (n=3, where n represents the number of extracted features) are extracted from each facial expression and a 2D manifold 250 may be formed to hold these extracted features.

In the illustrated embodiment, mapping of various dots relating to user expressions (e.g., facial expressions) is shown as in manifold 250 (shown as a grid), where a number of these dots are clustered together (shown as ellipses 251, 253) based on their features and other categories, such as class, sub-class, task, user, etc., where each dot relates to an extracted feature vector relating to a single expression, such as a facial expression. For example and as illustrated, ellipses 251, 253 having a cluster of dots relating to user facial expressions, such as smile 251, laugh 253, etc., where each ellipse 251, 253 is clusters together those facial expressions that are similar to each other. For example, the dots of ellipse 251 include facial expressions relating to the user's smile (e.g., how the upper lips moves as opposed to the lower lip, how much of the teeth are shown when smiling, etc.) to be used to infer the user's behavior regarding the user's facial expressions and how the user reacts, in general, and to various scenes, such as movie scenes, particular.

In one embodiment, using mapping logic 207 and clustering logic 209 of model engine 205, similar user expressions, as represented by the dots, are clustered together, such as those relating to the user's smile are clustered in a first ellipse, such as ellipse 251, and those relating to the user's laugh are clustered in a second ellipse, such as ellipse 253, while other dots relating to other facial expressions (such as anger, sadness, surprise, etc.) may remain isolated within manifold 250 until additional facial expressions are mapped as dots that similarly relate to the facial expressions whose feature vectors are represented by one or more of the isolated dots.

Now referring to FIG. 2C, it illustrates another embodiment of a manifold 260 according to one embodiment. As described with reference to manifold 250 of FIG. 2B, this learned manifold 260 illustrates the process of various dots, relating to user expressions, of the same class being clustered or condensed together, via cluster logic 209 of model engine 205 of FIG. 2A. As illustrated, in one embodiment, arrows 261, 263 that are pointing in a single direction are used for condensing the dots representing the same class of user expression into a single area, such as ellipses 251, 253 of FIG. 2B. It is further illustrated, in another embodiment, arrows 265 having pointers on both sides are shown as pushing the dots relating to different user expressions are pushed away from each other so they may be pushed into another direction to increase the distance between different class of user expression such that they can be clustered with other dots of their own class or simply remain in isolation.

In one embodiment, each point mapped on manifold 260 represents a user expression, such as a facial expression as facilitated by mapping logic 207 of FIG. 2A, and each ellipse 267, 269 represents clustered (or confined or compressed) user expressions defined to be of the same class for a given context, task, user, etc., and arrows 261, 263, 265 represent condensing or stretching of the manifold as described above and facilitated by cluster logic 209 of FIG. 2A. This technique allows for incorporating external knowledge in the form of labeling (e.g., in a fuzzy manner) facial expressions; for example, incorporating head pose information relating to a head of a person in the image.

As separately illustrated in FIG. 2C, arrows 261, 263 are shown to have one-sided pointers for pulling those points together that are of the same class of user expressions, such as darker points 271A-B being pulled together, and lighter points 273A-B being pulled together, while darker points 271A-B are being pulled away from lighter points 273A-B.

Further, new expressions, such as new facial expressions, relating to a specific user may be mapped onto manifold 260 and then, those mapped expressions that are found to be close enough in their respective classes to regions on the manifold having specific labels (representing relevant categories of user expressions). These expressions may also be assumed to have the same label as the region in which they belong and consequently, be labeled automatically. Further, these new user expressions may be used to update manifold 260 in a number of ways, such as 1) update the relevant databases 230, such as representative databases 231, 235, and 2) use the labels to calculate improved similarity and thus, condensing/stretching manifold 260 to adapt to the user.

FIG. 2D illustrates a graph 280 having user expression points planted in various clusters according to one embodiment. In one embodiment, each planted point represents a user expression (e.g., facial expression) where each shade or color represents a different class which are clustered together. The plane 281 marked as linear separation is shown to serve as a classifier 281 to separate one or more clusters from others, such as, as illustrated, cluster 283 of points representing happiness 283 is separated from all other clusters 285 representing other emotions. Similarly, regression is illustrated by an arrow 287 passing through the plane serving as classifier 281, where the points that are closer to the head or pointer of arrow 287 represent happiness and those that are closer to the tail of arrow 287 represent other emotions (e.g., anger, contempt, disgust, fear, less or lesser happiness, sadness, surprise) or, in some embodiments, lesser emotions than those that are closer to the head (such as less happier at the tail than at the head) as facilitated by classification/regression logic 221 of FIG. 2A.

FIG. 3A illustrates a transaction sequence 300 for efficiently performing affect-related adaptive representation and reasoning of user behavior relating to users expressions according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 300 may be performed by behavior mechanism 110 of FIG. 1. The processes of transaction sequence 300 are illustrated in linear sequences for brevity and clarity in presentation; however, it is contemplated that any number of them can be performed in parallel, asynchronously, or in different orders. For brevity, many of the details discussed with reference to FIGS. 1 and 2A-D may not be discussed or repeated hereafter.

In one embodiment, as aforementioned, various user expressions, such as facial expressions and other sensor expressions (e.g., voice characteristics), etc., may be detailed though a process for better inference leading to an affective state relating to the user. In the illustrated embodiment, online or real-time feature vectors 301 of various user expressions (e.g., facial expressions) may be received and extracted via one or more sources as described with reference to FIG. 2A.

In one embodiment, these feature vectors 301 may be used, at block 301, to generate and maintain, at 303, a representative expressions database, such as adapted representative database 231, which may be fed information, at 311, from one or more preliminary databases, such as preliminary representative database 235, which may be regarded as a starting point where preliminary expressions are gathered. The process may continue with using the user expressions for learning and updating of a manifold or subspace as shown in block 305, which may also receive external knowledge from one or more external sources, at 315, and may be further in communication with one or more other databases, such as adapted manifold database 233 which may be fed from another databases, such as preliminary manifold database 237.

In one embodiment, process may continue inference from the user expressions, such as classification, regression, and discovery of these user expressions (e.g., facial expressions) at block 307 to yield facial expression-related affect-based user behavior at 309. As illustrated, data from adapted manifold database 233 may be used to provide relevant user expression-related information to the process of block 303 as well as to block 307 for inference purposes. With inference processing at block 307, any relevant data, such as classification results (e.g., label and confidence, such as the color of each point and its location inside its corresponding ellipse, etc.) may then be shared with the generation and maintenance process at 303. The two preliminary databases 235 and 237 contain preliminary data for adapted databases 231 and 233, respectively.

In one embodiment, model engine 205 of FIG. 2A relates to and provides representing and modeling human expressions by one or more adaptable models, such as adapted representative database 231, adapted manifold database 233, etc. Similarly, learning engine 211 of FIG. 2A relates to and provides learning and adapting of the aforementioned adaptable model, where this learning and adapting process is performed through processes of blocks 303 and 305. Similarly, inference engine 219 of FIG. 2A relates to and provides a rich set of adaptive reasoning capabilities as shown in block 307, producing affect-based user behavior at 309.

FIG. 3B illustrates a sectional transaction sequence 330 of transaction sequence 300 of FIG. 3A for efficiently performing affect-related adaptive representation and reasoning of user behavior relating to users expressions according to one embodiment. Transaction sequence 330 may be performed by processing logic that may comprise hardware (e.g., circuitry, dedicated logic, programmable logic, etc.), software (such as instructions run on a processing device), or a combination thereof. In one embodiment, transaction sequence 330 may be performed by behavior mechanism 110 of FIG. 1. The processes of transaction sequence 330 are illustrated in linear sequences for brevity and clarity in presentation; however, it is contemplated that any number of them can be performed in parallel, asynchronously, or in different orders. For brevity, many of the details discussed with reference to FIGS. 1, 2A-D and 3A may not be discussed or repeated hereafter

In one embodiment, as aforementioned, a manifold of user expressions is learned by first, generating a database of representative user expressions, and second, evaluating similarities between pairs of user expressions, and third, calculating the manifold. As illustrated, a representative database, such as adapted representative database 231, may be generated and maintained at block 303. These feature vectors 301 represents facial expressions from which a manifold may be learned in the following processes.

Transaction sequence 330 provides a scheme representing a first stage to set a representative set of user expressions (e.g., feature vectors) or a set of pseudo/prototypical user expressions to be used for learning the manifold. This information about the manifold may be used to iteratively fine tune the adapted representative database, such as adapted representative database 231, as indicated by the loop of arrows running to next states of manifold learning and then back into block 303 with two more arrows representing interference results of test dataset and learned manifold parameters for measuring manifold quality.

This adapted representative database 231 may be kept as small as possible while preserving the statistical properties of the facial expressions' domain (e.g., contexts, tasks, users, etc.), where one or more algorithms, such as Vector-Quantization, may be used for building adapted representative database at block 303. For example, this adapted representative database 231 may contain pseudo user expressions and parameters capturing various deviations. Further, for example, any pseudo user expressions may represent a set of average or prototypical user expressions for different user expression categories.

In one embodiment, by iteratively evaluating the quality of learned manifold as facilitated by evaluation logic 215, the best representative database, such as adapted representative database 231, of facial expressions is generated. In one embodiment, the quality of the manifold may be represented by the quality of a reasoning task (e.g., classification, regression, etc.) and a predefined test set of validation may be fed into the reasoning component, where the quality of the outcome may be measured. The quality of the manifold may also be measured in general or alternatively as the quality of a specific reasoning task under a specific context or the performance of a specific user.

In one embodiment, similarities between pairs of facial expressions may be calculated by calculation logic 217, such as by taking into account various parameters or factors, such as labels, class, type, etc., of each facial expression. For example, facial expressions belonging to the same class, under a given context or tasks, may be pushed into other facial expressions of similar class or pulled away from facial expressions of different classes. In one embodiment, this class-based similarity measurement may be defined as Sim(X,Y)=k*1/|X−Y|, where k is selected to be a small number if X and Y belong to the same class; otherwise, k is selected to be a large number.

FIG. 3C illustrates a transaction sequence 350 for efficiently performing affect-related adaptive representation and reasoning of user behavior relating to users expressions according to one embodiment. Transaction sequence 350 may be performed by processing logic that may comprise hardware (e.g., circuitry, dedicated logic, programmable logic, etc.), software (such as instructions run on a processing device), or a combination thereof. In one embodiment, transaction sequence 350 may be performed by behavior mechanism 110 of FIG. 1. The processes of transaction sequence 350 are illustrated in linear sequences for brevity and clarity in presentation; however, it is contemplated that any number of them can be performed in parallel, asynchronously, or in different orders. For brevity, many of the details discussed with reference to FIGS. 1, 2A-D and 3A-3B may not be discussed or repeated hereafter.

Like transaction sequence 300 discussed above with respect to FIG. 3A, transaction sequence 350 begins with receiving feature vectors of various user expressions (e.g., facial expressions) at 301. In one embodiment, the process may then continue, at 351, with the mapping of these feature vectors to a manifold, such as manifold 250 of FIG. 2B. As described with reference to FIG. 2A and illustrated with reference to FIG. 3A, manifold 250 receives various user expressions-related data from one or more databases, such as adapted manifold database 233. Further, for example, at 315, any amount and type of context and external knowledge or data may be fed into learning and adapting process to further calibrate the process. As further described with reference to FIG. 2A and illustrated with reference to FIG. 3A, at 305, learning and adapting processes may be performed and this information may then be used to perform inference processes, at 307, to obtain affect-based user behavior.

As further illustrated, the process continue with iteration, such as additional ellipses, such as ellipses 267, 269 of FIG. 2C, having various points representing user expressions may be generated and this data may then be again fed into manifold 250 via as adapted manifold database 233. Transaction sequence 350 further illustrates a graph, such as graph 280 of FIG. 2D, illustrating a number of clusters of pointes representing different classes of user expressions being separated by a classifier plane, such as classifier 281 of FIG. 2D, and an arrow, such as arrow 287 of FIG. 2D, indicting the direction of flow of various classified emotions (e.g., smile, laugh, anger, etc.) reflected by the user expressions.

FIG. 3D illustrates a method 370 for efficiently performing affect-related adaptive representation and reasoning of user behavior relating to users expressions according to one embodiment. Method 370 may be performed by processing logic that may comprise hardware (e.g., circuitry, dedicated logic, programmable logic, etc.), software (such as instructions run on a processing device), or a combination thereof. In one embodiment, method 370 may be performed by behavior mechanism 110 of FIG. 1. The processes of method 370 are illustrated in linear sequences for brevity and clarity in presentation; however, it is contemplated that any number of them can be performed in parallel, asynchronously, or in different orders. For brevity, many of the details discussed with reference to FIGS. 1, 2A-D and 3A-3C may not be discussed or repeated hereafter.

Method 370 begins at block 371 with receiving of various user expressions (e.g., facial expressions, voice characteristics, etc.) from one or more sources, such a camera, a microphone, etc. At block 373, any number and type of feature vectors are extracted from the user expressions, where each feature vector represents a particular feature (e.g., features relating to smiling, laughing, anger, sadness, etc.) relating to each user expression. At block 375, these user expressions are mapped on a manifold (e.g., a mathematical model) based on their feature vectors.

At block 377, in one embodiment, the model is then learned or adapted online or on-the-fly to learn as much information as possible about each user or group or sub-group of user (e.g., users sharing similar attributes or classifications, such as age, gender, ethnicity, etc.), where the information includes or is based on any number and type of factors specific to the user or the group/sub-group of user, such as age, gender, ethnicity, race, cultural mannerisms, physiological features or limitations, personality traits, and emotional states. At block 379, in one embodiment, using the aforementioned learning, an adaptive reasoning is generated for each user and their corresponding user expressions. At block 381, inference from the adaptive is obtained to form affect-based user behavior and outputted for better interpretation of user expressions.

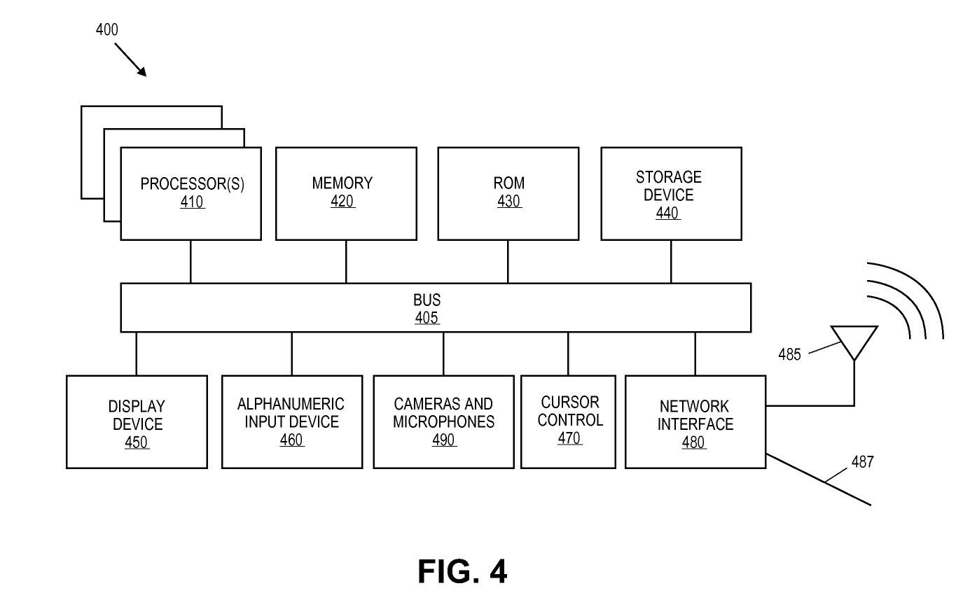

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 400 may be the same as or similar to or include computing devices 100 described in reference to FIG. 1.

Computing system 400 includes bus 405 (or, for example, a link, an interconnect, or another type of communication device or interface to communicate information) and processor 410 coupled to bus 405 that may process information. While computing system 400 is illustrated with a single processor, it may include multiple processors and/or co-processors, such as one or more of central processors, image signal processors, graphics processors, and vision processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate affect-based adaptive representation of user behavior relating to user expressions on computing devices, comprising: reception/detection logic to receive a plurality of expressions communicated by a user, wherein the plurality of expressions includes one or more visual expressions or one or more audio expressions; features extraction logic to extract a plurality of features associated with the plurality of expressions, wherein each feature reveals a behavior trait of the user when the user communicates a corresponding expression; mapping logic of a model engine to map the plurality of expressions on a model based on the plurality of features; and discovery logic of an inference engine to discover a behavioral reasoning associated with each of the plurality of expressions communicated by the user based on a mapping pattern as inferred from the model.

Example 2 includes the subject matter of Example 1, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices, wherein the plurality of expressions are communicated via communication/compatibility logic.

Example 3 includes the subject matter of Example 1, wherein the model engine further comprises cluster logic to facilitate clustering of the plurality of expressions on the model based on classifications associated with the plurality of expressions, wherein each of the plurality of expressions corresponds to at least one classification.

Example 4 includes the subject matter of Example 1, wherein the interference engine further comprises classification/regression logic to: push together, on the model, two or more of the plurality of expressions associated with a same classification; and pull away, on the model, two or more of the plurality of expressions associated with different classifications.

Example 5 includes the subject matter of Example 1, further comprising database generation logic of a learning/adapting engine to generate one or more representative databases to maintain representation data relating to the plurality of features associated with the plurality of expressions, wherein the representation data includes pseudo expressions or prototypical expressions relating to the plurality of features.

Example 6 includes the subject matter of Example 5, wherein the learning/adapting engine further comprises: evaluation logic to iteratively evaluate the representation data to determine one or more reasoning tasks to be performed on the plurality of expressions, wherein the one or more reasoning tasks include pushing together or the pulling away of the two or more of the plurality of expressions; and calculation logic to determine classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

Example 7 includes the subject matter of Example 5, wherein the database generation logic is further to maintain one or more preliminary databases having preliminary data relating to the representative data, wherein the preliminary data includes at least one of historically-maintained data or externally-received data relating to the representative data, wherein the preliminary databases are coupled to the representative databases.

Some embodiments pertain to Example 8 that includes a method for facilitating affect-based adaptive representation of user behavior relating to user expressions on computing devices on computing devices, comprising: receiving a plurality of expressions communicated by a user, wherein the plurality of expressions includes one or more visual expressions or one or more audio expressions; extracting a plurality of features associated with the plurality of expressions, wherein each feature reveals a behavior trait of the user when the user communicates a corresponding expression; mapping the plurality of expressions on a model based on the plurality of features; and discovering a behavioral reasoning associated with each of the plurality of expressions communicated by the user based on a mapping pattern as inferred from the model.

Example 9 includes the subject matter of Example 8, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices.

Example 10 includes the subject matter of Example 8, further comprising facilitating clustering of the plurality of expressions on the model based on classifications associated with the plurality of expressions, wherein each of the plurality of expressions corresponds to at least one classification.

Example 11 includes the subject matter of Example 8, further comprising: pushing together, on the model, two or more of the plurality of expressions associated with a same classification; and pulling away, on the model, two or more of the plurality of expressions associated with different classifications.

Example 12 includes the subject matter of Example 8, further comprising database generation logic of a learning/adapting engine to generate one or more representative databases to maintain representation data relating to the plurality of features associated with the plurality of expressions, wherein the representation data includes pseudo expressions or prototypical expressions relating to the plurality of features.

Example 13 includes the subject matter of Example 12, further comprising: iteratively evaluating the representation data to determine one or more reasoning tasks to be performed on the plurality of expressions, wherein the one or more reasoning tasks include pushing together or the pulling away of the two or more of the plurality of expressions; and determining classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

Example 14 includes the subject matter of Example 12, further comprising maintaining one or more preliminary databases having preliminary data relating to the representative data, wherein the preliminary data includes at least one of historically-maintained data or externally-received data relating to the representative data, wherein the preliminary databases are coupled to the representative databases.

Example 15 includes at least one machine-readable medium comprising a plurality of instructions, when executed on a computing device, to implement or perform a method or realize an apparatus as claimed in any preceding claims.

Example 16 includes at least one non-transitory or tangible machine-readable medium comprising a plurality of instructions, when executed on a computing device, to implement or perform a method or realize an apparatus as claimed in any preceding claims.

Example 17 includes a system comprising a mechanism to implement or perform a method or realize an apparatus as claimed in any preceding claims.

Example 18 includes an apparatus comprising means to perform a method as claimed in any preceding claims.

Example 19 includes a computing device arranged to implement or perform a method or realize an apparatus as claimed in any preceding claims.

Example 20 includes a communications device arranged to implement or perform a method or realize an apparatus as claimed in any preceding claims.

Some embodiments pertain to Example 21 includes a system comprising a storage device having instructions, and a processor to execute the instructions to facilitate a mechanism to perform one or more operations comprising: receiving a plurality of expressions communicated by a user, wherein the plurality of expressions includes one or more visual expressions or one or more audio expressions; extracting a plurality of features associated with the plurality of expressions, wherein each feature reveals a behavior trait of the user when the user communicates a corresponding expression; mapping the plurality of expressions on a model based on the plurality of features; and discovering a behavioral reasoning associated with each of the plurality of expressions communicated by the user based on a mapping pattern as inferred from the model.

Example 22 includes the subject matter of Example 21, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices.

Example 23 includes the subject matter of Example 21, wherein the one or more operations further comprise facilitating clustering of the plurality of expressions on the model based on classifications associated with the plurality of expressions, wherein each of the plurality of expressions corresponds to at least one classification.

Example 24 includes the subject matter of Example 21, wherein the one or more operations further comprise: pushing together, on the model, two or more of the plurality of expressions associated with a same classification; and pulling away, on the model, two or more of the plurality of expressions associated with different classifications.

Example 25 includes the subject matter of Example 21, wherein the one or more operations further comprise database generation logic of a learning/adapting engine to generate one or more representative databases to maintain representation data relating to the plurality of features associated with the plurality of expressions, wherein the representation data includes pseudo expressions or prototypical expressions relating to the plurality of features.

Example 26 includes the subject matter of Example 25, wherein the one or more operations further comprise: iteratively evaluating the representation data to determine one or more reasoning tasks to be performed on the plurality of expressions, wherein the one or more reasoning tasks include pushing together or the pulling away of the two or more of the plurality of expressions; and determining classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

Example 27 includes the subject matter of Example 25, wherein the one or more operations further comprise maintaining one or more preliminary databases having preliminary data relating to the representative data, wherein the preliminary data includes at least one of historically-maintained data or externally-received data relating to the representative data, wherein the preliminary databases are coupled to the representative databases.

Some embodiments pertain to Example 28 includes an apparatus comprising: means for receiving a plurality of expressions communicated by a user, wherein the plurality of expressions includes one or more visual expressions or one or more audio expressions; means for extracting a plurality of features associated with the plurality of expressions, wherein each feature reveals a behavior trait of the user when the user communicates a corresponding expression; means for mapping the plurality of expressions on a model based on the plurality of features; and means for discovering a behavioral reasoning associated with each of the plurality of expressions communicated by the user based on a mapping pattern as inferred from the model.

Example 29 includes the subject matter of Example 28, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices.

Example 30 includes the subject matter of Example 28, further comprising means for facilitating clustering of the plurality of expressions on the model based on classifications associated with the plurality of expressions, wherein each of the plurality of expressions corresponds to at least one classification.

Example 31 includes the subject matter of Example 28, further comprising: means for pushing together, on the model, two or more of the plurality of expressions associated with a same classification; and means for pulling away, on the model, two or more of the plurality of expressions associated with different classifications.

Example 32 includes the subject matter of Example 28, further comprising means for generating one or more representative databases to maintain representation data relating to the plurality of features associated with the plurality of expressions, wherein the representation data includes pseudo expressions or prototypical expressions relating to the plurality of features.

Example 33 includes the subject matter of Example 32, further comprising: means for iteratively evaluating the representation data to determine one or more reasoning tasks to be performed on the plurality of expressions, wherein the one or more reasoning tasks include pushing together or the pulling away of the two or more of the plurality of expressions; and means for determining classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

Example 34 includes the subject matter of Example 32, further comprising means for maintaining one or more preliminary databases having preliminary data relating to the representative data, wherein the preliminary data includes at least one of historically-maintained data or externally-received data relating to the representative data, wherein the preliminary databases are coupled to the representative databases.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
reception/detection logic to receive a plurality of expressions communicated by a user, wherein the plurality of expressions includes one or more visual expressions or one or more audio expressions;
features extraction logic to extract a plurality of features associated with the plurality of expressions, wherein each feature reveals a behavior trait of the user when the user communicates a corresponding expression;
mapping logic of a model engine to map the plurality of expressions on a model based on the plurality of features; and
discovery logic of an inference engine to discover a behavioral reasoning associated with each of the plurality of expressions communicated by the user based on a mapping pattern as inferred from the model.

2. The apparatus of claim 1, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices, wherein the plurality of expressions are communicated via communication/compatibility logic.

3. The apparatus of claim 1, wherein the model engine further comprises cluster logic to facilitate clustering of the plurality of expressions on the model based on classifications associated with the plurality of expressions, wherein each of the plurality of expressions corresponds to at least one classification.

4. The apparatus of claim 1, wherein the interference engine further comprises classification/regression logic to:
push together, on the model, two or more of the plurality of expressions associated with a same classification; and
pull away, on the model, two or more of the plurality of expressions associated with different classifications.

5. The apparatus of claim 1, further comprising database generation logic of a learning/adapting engine to generate one or more representative databases to maintain representation data relating to the plurality of features associated with the plurality of expressions, wherein the representation data includes pseudo expressions or prototypical expressions relating to the plurality of features.

6. The apparatus of claim 5, wherein the learning/adapting engine further comprises:
evaluation logic to iteratively evaluate the representation data to determine one or more reasoning tasks to be performed on the plurality of expressions, wherein the one or more reasoning tasks include pushing together or the pulling away of the two or more of the plurality of expressions; and
calculation logic to determine classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

7. The apparatus of claim 5, wherein the database generation logic is further to maintain one or more preliminary databases having preliminary data relating to the representative data, wherein the preliminary data includes at least one of historically-maintained data or externally-received data relating to the representative data, wherein the preliminary databases are coupled to the representative databases.

8. A method comprising:
receiving a plurality of expressions communicated by a user, wherein the plurality of expressions includes one or more visual expressions or one or more audio expressions;
extracting a plurality of features associated with the plurality of expressions, wherein each feature reveals a behavior trait of the user when the user communicates a corresponding expression;
mapping the plurality of expressions on a model based on the plurality of features; and
discovering a behavioral reasoning associated with each of the plurality of expressions communicated by the user based on a mapping pattern as inferred from the model.

9. The method of claim 8, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices.

10. The method of claim 8, further comprising facilitating clustering of the plurality of expressions on the model based on classifications associated with the plurality of expressions, wherein each of the plurality of expressions corresponds to at least one classification.

11. The method of claim 8, further comprising:
pushing together, on the model, two or more of the plurality of expressions associated with a same classification; and
pulling away, on the model, two or more of the plurality of expressions associated with different classifications.

12. The method of claim 8, further comprising generating one or more representative databases to maintain representation data relating to the plurality of features associated with the plurality of expressions, wherein the representation data includes pseudo expressions or prototypical expressions relating to the plurality of features.

13. The method of claim 12, further comprising:
iteratively evaluating the representation data to determine one or more reasoning tasks to be performed on the plurality of expressions, wherein the one or more reasoning tasks include pushing together or the pulling away of the two or more of the plurality of expressions; and
determining classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

14. The method of claim 12, further comprising maintaining one or more preliminary databases having preliminary data relating to the representative data, wherein the preliminary data includes at least one of historically-maintained data or externally-received data relating to the representative data, wherein the preliminary databases are coupled to the representative databases.

15. At least one machine-readable medium comprising a plurality of instructions, executed on a computing device, to facilitate the computing device to perform one or more operations comprising:
receiving a plurality of expressions communicated by a user, wherein the plurality of expressions includes one or more visual expressions or one or more audio expressions;
extracting a plurality of features associated with the plurality of expressions, wherein each feature reveals a behavior trait of the user when the user communicates a corresponding expression;
mapping the plurality of expressions on a model based on the plurality of features; and
discovering a behavioral reasoning associated with each of the plurality of expressions communicated by the user based on a mapping pattern as inferred from the model.

16. The machine-readable medium of claim 15, wherein the behavioral reasoning is based on a plurality of factors specific to the user, wherein the plurality of factors include one or more of age, gender, ethnicity, race, cultural mannerisms, physiological features or limitations, personality traits, and emotional states, and wherein the plurality of expressions are captured via one or more capturing/sensing devices including one or more of a camera, a microphone, and a sensor, and wherein the plurality of expressions are displayed via one or more display devices.

17. The machine-readable medium of claim 15, wherein the one or more operations further comprise facilitating clustering of the plurality of expressions on the model based on classifications associated with the plurality of expressions, wherein each of the plurality of expressions corresponds to at least one classification.

18. The machine-readable medium of claim 15, wherein the one or more operations further comprise:
pushing together, on the model, two or more of the plurality of expressions associated with a same classification; and
pulling away, on the model, two or more of the plurality of expressions associated with different classifications.

19. The machine-readable medium of claim 15, wherein the one or more operations further comprise generating one or more representative databases to maintain representation data relating to the plurality of features associated with the plurality of expressions, wherein the representation data includes pseudo expressions or prototypical expressions relating to the plurality of features.

20. The machine-readable medium of claim 19, wherein the one or more operations further comprise:
iteratively evaluating the representation data to determine one or more reasoning tasks to be performed on the plurality of expressions, wherein the one or more reasoning tasks include pushing together or the pulling away of the two or more of the plurality of expressions; and
determining classification of each of the classifications associated with each of the plurality of expressions mapped on the model, wherein a classification is based on an emotional context of the user, wherein the emotional context includes one or more of smile, laugh, happiness, sadness, anger, anguish, fear, surprise, sock, and depression.

21. The machine-readable medium of claim 19, wherein the one or more operations further comprise maintaining one or more preliminary databases having preliminary data relating to the representative data, wherein the preliminary data includes at least one of historically-maintained data or externally-received data relating to the representative data, wherein the preliminary databases are coupled to the representative databases.
